(19) United States
(12) Patent Application Publication
(10) Pub. No.: US 2015/0224428 A1
(43) Pub. Date: Aug. 13, 2015

(54) BACKPRESSURE CONTROL FOR SOLID/FLUID SEPARATION APPARATUS

(71) Applicant: GreenField Specialty Alcohols Inc., Toronto (CA)

(72) Inventors: Richard Romeo LEHOUX, Windsor (CA); Christopher Bruce BRADT, LaSalle (CA); Jeffery Alan WOOD, London (CA)

(21) Appl. No.: 14/562,072

(22) Filed: Dec. 5, 2014

Related U.S. Application Data
(60) Provisional application No. 61/912,322, filed on Dec. 5, 2013.

(51) Int. Cl. B01D 33/00

(52) U.S. Cl. CPC B01D 33/009

(57) ABSTRACT

A device and method for controlling backpressure in a screw conveyor press including barrel and one or more conveyor screws in the housing is disclosed. The device includes a barrel block for forming an axial section of the barrel and having a pressure surface for facing the conveyor screw. At least a portion of the barrel block is deformable for adjusting a spacing between at least a portion of the pressure surface and the conveyor screw. An arrangement for deforming the deformable portion, for example a hydraulic or mechanical deforming arrangement, can be included. Substantially the whole barrel block can be made of deformable material, preferably elastically deformable material. The device can further include a casing for enclosing the barrel block and the arrangement for deforming can be positioned between the casing and the barrel block. The device provides for backpressure control independent of conveyor screw rpm.

This application claims the benefit of priority of U.S. Provisional Patent Application No. 61/916,995 filed Dec. 17, 2013, which is incorporated herein by reference in its entirety.

### FIELD OF THE INVENTION

The present invention relates to solid/fluid separation and in particular solid/fluid separation under pressure.

### BACKGROUND OF THE INVENTION

Various processes for process feed or process residue treatment by solid/liquid separation are known which require significant residence time, high pressure and high temperature. Generally, liquids must be separated from treated solids at those conditions. Conventional liquid/solid separation equipment is not satisfactory for the achievement of high liquids/solids separation rates and for the processing of solids with low liquid content.

Solid/liquid separation is generally done by filtration and either in batch operation, with filter presses, or continuously by way of screw presses, or extruder presses. Many biomass to ethanol processes generate a wet fiber slurry from which dissolved compounds and liquid must be separated at various process steps to isolate a solid fibrous portion. For example, a key component of process efficiency in the pretreatment of lignocellulosic biomass is the ability to wash and squeeze hydrolyzed hemi-cellulose sugars, toxins, inhibitors and/or other extractives from the solid biomass/cellulose fraction. It is difficult to effectively separate solids from liquid under the high heat and pressure required for cellulose pre-treatment.

Solid/liquid separation is also necessary in many other commercial processes, such as food processing (oil extraction), reduction of waste stream volume in wet extraction processes, dewatering processes, suspended solids removal.

Commercial screw presses can be used to remove moisture from a solid/liquid slurry. However, the remaining de-liquefied solids cake generally contains only 40-50% solids. This level of separation may be satisfactory when the filtration step is followed by another dilution or treatment step, but not when maximum dewatering of the slurry is desired, the leftover moisture being predominantly water. This unsatisfactory low solids content is due to the relatively low maximum pressure conventional screw presses can handle, which is generally not more than about 100-300 psig of separation pressure. However, their drawbacks are their inherent cost, complexity and continued filter cake limitation of no more than 50% solids content.

During solid/fluid separation, the amount of liquid remaining in the solids fraction is dependent on the amount of separating pressure applied, the thickness of the solids cake, and the porosity of the filter. A reduction in pressure, an increase in cake thickness or a decrease in porosity of the filter, will all result in a decrease in the degree of liquid/solid separation and the ultimate degree of dryness of the solids fraction. For a particular solids cake thickness and filter porosity, maximum separation is achieved at the highest separating pressure possible.

Conventional single, twin, or triple screw extruders do not have the residence time necessary for low energy pre-treatment of biomass, and also do not have useful and efficient solid/fluid separating devices for the pre-treatment of biomass. U.S. Pat. No. 3,230,865 and U.S. Pat. No. 7,347,140 disclose screw presses with a perforated casing. Operating pressures of such a screw press are low, due to the low strength of the perforated casing. U.S. Pat. No. 5,515,776 discloses a worm press and drainage perforations in the press jacket, which increase in cross-sectional area in flow direction of the drained liquid. U.S. Pat. No. 7,357,074 is directed to a screw press with a conical dewatering housing with a plurality of perforations for the drainage of water from bulk solids compressed in the press. Again, a perforated casing or jacket is used.

Published U.S. Application US 2012/0118517 discloses screw press style solid/liquid separation apparatus including a screw assembly having a barrel which houses a press screw. The barrel may house two or more parallel or non-parallel screws with at least partially intercalated flighting. The flighting of the screws may be intercalated at least along a part of the length of the extruder barrel to define a close clearance between the pair of screws and between the screws and the filter or solid barrel opening. The close clearance reduces reverse slippage of the material backward while conveying forward. A solid/fluid separation module with high porosity for separation at elevated pressures is incorporated into the barrel. The filter module is intended for use in screw press type systems and includes filter packs respectively made of a pair of plates that create a drainage system. A filter plate with slots creates flow channels for the liquid to be removed and a backer plate creates the support for containing the internal pressure of the solids during the squeezing action and for creating a drainage passage for the flow channels. To control the internal squeezing pressure, the rpm or the configuration of the press screw, or screws, is adjusted, or an adjustable die at the outlet end of the barrel is used. Controlling the rotation speed/RPM of the screws is the only manner in which continuous control of the internal squeezing pressure on the slurry can be achieved in conventional presses. Moreover, there is no method of clearing the barrel when it becomes plugged, other than dismantling the screw press. The usefulness of the die is limited, since it will plug when high solids content materials are encountered. Optimization of product throughput and dryness is difficult to achieve with pressure control limited to RPM control. Also as the input feedstock can vary in moisture content controlling internal pressure solely by the rpm of the press screw may not be achievable. Finally, prevention of plugging by rpm control is not reliable.

The development of the internal or “squeezing” pressure within the barrel is accomplished by the forward conveying of the solid/liquid material produced by forward conveying elements on the screw and by restriction to that flow, caused by other types of screw elements that do not have the same forward conveying capacity. This pressure generation is a function of the forward forces caused by the most forward conveying flighting acting against the forces of the flow restricting screw elements. Besides the screw elements themselves, the rpm of the screw elements, the friction factor between the screw elements and the solid/liquid material, the rheology/viscosity of the solid/liquid material, and the clearance between the screw elements and the barrel also affect the internal pressure developed.

In common screw type presses, once an internal screw configuration has been installed in the device and is operating at constant temperature, the only items which can vary the internal pressure are the rpm of the screw, the properties that affect the rheology/viscosity of the solid/liquid material and the friction factor between screw elements and the solid/liquid material. Properties which are known to have an effect on friction and rheology are the percentage of water in the solid/liquid material and the dissolved solids content (percentage of dissolved solids such as sugars, proteins, salts, fats, etc.) in the water within the solid/liquid material. Other factors which can affect these properties, including the amount of shear energy applied to the solid/liquid material, are much more difficult to quantify.

In all solid/liquid separation applications, the amount of water in the material is progressively reduced as it passes through the screw press. For any given material feed, screw element, and filter/barrel configuration at constant rpm and temperature, the conveying forces generated are affected by the solid/liquid material properties, which affect the flow of the material. One key property of the solid/liquid material, which significantly affects flow is the viscosity of the solid-liquid material and key to the viscosity of the solid-liquid material is the size of the liquid portion in comparison to the solids portion or the % dry matter. Material with a high dry matter content has a higher viscosity and a greater resistance to flow resulting in the potential to generate high pressures. Materials with a low dry matter content have lower viscosity and lower resistance to flow resulting in less potential to generate pressure. As the water content decreases, the solids content increases and the friction factor and rheology changes. This affects the ability of the screw to generate internal pressure. In most instances, removing water from the material results in a higher friction factor and higher viscosity, meaning that the internal force produced by a particular screw at a particular rpm on the solid/liquid material increases as the water content decreases. The lower the amount of solids (therefore higher amount of liquid) present in a solid-liquid mixture, the less friction the mixture has with the screw and the less force/pressure it can generate at a particular rpm on the solid/liquid material.

To create an internal pressure, the forward conveying/movement of material generated by the flighting on the screw(s) must be counteracted by some form of restriction to the movement of the material. The restriction to material movement can be achieved using different screw configurations, but is caused in all cases by a decrease in the screw element's ability to forward convey at a point downstream of the pressure measuring point. Control of the backpressure generation of a reverse conveying section or less forward conveying section is currently limited to adjustment of the rotational speed/rpm of the extruder screw and the potential use of a die downstream of the extruder screw.

### SUMMARY OF THE INVENTION

It is an object of the present disclosure to provide a device and method for controlling backpressure in a screw conveyor press to overcome at least one of the disadvantages of the art discussed above.

In one embodiment, the present disclosure provides a method for controlling backpressure in a screw press or extruder press, in the following generally referred to as a screw conveyor press. Backpressure is controlled by modifying a spacing or clearance between the barrel of the screw conveyor press and the press screw or extruder screw, in the following generally referred to as conveyor screw. The clearance is modified in at least one axial portion of the barrel, in the following also referred to as the barrel block. Modification of the clearance is achieved by moving a pressure surface of the barrel block towards or away from the conveyor screw. If intercalated conveyor screws are present, the clearance is preferably modified at least in the region of overlap of the conveyor screws.

In another embodiment, the present disclosure provides a device for controlling backpressure in a screw conveyor press including a conveyor screw and a barrel housing the conveyor screw. The device includes a barrel block forming an axial section of the barrel and having an interior wall or pressure surface for facing the conveyor screw. At least a portion of the barrel block is deformable for adjusting a spacing between the pressure surface and the conveyor screw. The device preferably further includes an arrangement for controllably deforming the deformable portion to move the pressure surface towards or away from the conveyor screw. Preferably the arrangement is a mechanism for deforming the deformable portion.

In a preferred embodiment, the whole barrel block is deformable and the device includes a casing for enclosing the barrel block. In another preferred embodiment, the arrangement is a hydraulic arrangement for compressing the barrel block. Alternatively, the arrangement may be a mechanism for compressing the barrel block.

In a further preferred embodiment, the deformable portion is made of elastically deformable material. Alternatively, the whole barrel block can be made of elastically deformable material.

In another embodiment, the present disclosure provides a method of increasing backpressure in a screw conveyor press including a conveyor screw and a barrel housing the conveyor screw. In a preferred embodiment, the method includes the steps of decreasing a spacing or clearance between an axial section of the barrel and the conveyor screw, preferably by deforming a portion of the axial section. The axial section preferably includes a pressure surface for facing the conveyor screw and the deforming moves the pressure surface closer to the conveyor screw.

In a further embodiment, the present disclosure provides a method of decreasing backpressure in a screw conveyor press, including a conveyor screw and a barrel housing the conveyor screw. In a preferred embodiment, the method includes the steps of increasing a spacing or clearance between an axial section of the barrel and the conveyor screw, preferably by deforming a portion of the axial section. The axial section preferably includes a pressure surface for facing the conveyor screw and the deforming moves the pressure surface further away from the conveyor screw.

In another embodiment, the present disclosure provides a method of controlling backpressure in a screw conveyor press including a conveyor screw and a barrel housing the conveyor screw, the method including the steps of providing a deformable barrel portion having a pressure surface facing the conveyor screw and increasing the backpressure by deforming the barrel portion for moving the pressure surface towards the conveying screw for decreasing a clearance or spacing between the barrel portion and the conveyor screw until a desired backpressure is reached. Conversely, the present disclosure provides a method of decreasing the backpressure by deforming the barrel portion to move the pressure surface away from the conveying screw for increasing the clearance or spacing, when the backpressure exceeds the desired backpressure. The deformable barrel portion is preferably made of elastically deformable material and the deforming of the section to move the pressure surface towards the conveying screw preferably includes deforming the section of the barrel from a relaxed condition to a deformed, compressed condition. Deforming of the section to move the pressure surface away from the conveyor screw then includes allowing the adjustable barrel section to relax at least partially from the compressed condition. In screw conveyor presses using multiple intercalated conveyor screws, the adjustable section is preferably deformable to move the pressure surface towards and away from the area(s) at which the screws meet or overlap.

In still a further embodiment, the device is used for controlling backpressure generation of a reverse conveying section in the screw conveyor press and includes a barrel block for forming a section of the barrel surrounding at least an axial portion of the reverse conveying section. The plug body includes a deformable portion and a pressure surface for facing the conveyor screw. The device preferably includes an arrangement for deforming the deformable portion for adjusting a spacing between the reverse conveying section and the barrel section by deforming the barrel block to move the pressure surface closer to the reverse conveying section and reduce the intermediate clearance, or further away from the reverse conveying section to increase the intermediate clearance. In one variant, substantially the whole barrel block is deformable.

In still a further embodiment of the method of the present disclosure, the method is used for controlling the backpressure generation of a reverse conveying section in the screw conveyor press and includes the steps of incorporating in the barrel an adjustable barrel block for forming a section of the barrel surrounding at least an axial portion of the reverse conveying section, the adjustable barrel block including at least one deformable portion, deforming the deformable portion for adjusting a spacing between the reverse conveying section and the barrel section by deforming the barrel block towards the reverse conveying section to reduce the spacing until a desired backpressure in the screw press is achieved. In a preferred embodiment, the substantially the whole adjustable barrel block is deformable. The method preferably includes the further steps of monitoring the backpressure in the press and, when the backpressure rises above the desired backpressure, deforming the deformable portion away from the reverse conveying section to increase the spacing to reduce the backpressure in the barrel to the desired backpressure. In a preferred embodiment, this method includes, for preventing or reversing plugging in the reverse conveying section, the further steps of monitoring a material throughput of the screw conveyor press and, when the material throughput approaches a value indicating plugging of the press, deforming the adjustable barrel block away from the reverse conveying section to increase the spacing until material throughput is reestablished. In another preferred embodiment, the monitoring of the pressure in the press is achieved by monitoring the forces needed to deform and maintain the deformation of the deformable portion during operation of the press. Most preferably this is achieved with a pressure transducer on or in the barrel block, or a pressure transducer included in the structure used to deform the deformable portion.

In yet another embodiment of the method of the present disclosure, the method is used for ensuring continuous operation of a screw conveyor press and includes the steps of incorporating in the barrel a deformable barrel block for forming a section of the barrel surrounding at least an axial portion of the reverse conveying section, deforming the barrel block for adjusting a spacing between the reverse conveying section and the barrel section by deforming the barrel block towards the reverse conveying section to reduce the spacing until a desired backpressure in the screw press is achieved, monitoring a material throughput of the screw conveyor press and, when the material throughput approaches a value indicating imminent or actual plugging of the press, deforming the barrel block away from the reverse conveying section to increase the spacing until material throughput is re-established.

In still yet another embodiment, the present disclosure provides an adjustable barrel section for controlling backpressure generation in a screw conveyor press including a conveyor screw and a barrel housing the screw, the barrel including multiple sections, the adjustable barrel section comprising a casing for incorporation into the barrel and connection to at least one other barrel section, and a flexible barrel block for surrounding at least an axial portion of the conveyor screw, the flexible barrel block having a pressure surface facing the axial portion and being deformable for moving the pressure surface closer to or further away from the conveyor screw, and means for deforming the flexible wall towards and away from the conveyor screw for adjusting a spacing between the reverse conveying section and the flexible internal wall. Preferably, substantially the whole the flexible barrel block is made of elastically deformable material, more preferably rubber material, or polymeric elastic material. Most preferably, the pressure surface of the flexible barrel block includes at least one of a friction reducing finish and a wear reducing finish. The wear reducing finish can be provided by at least one wear material insert, or by a wear material cover on the barrel block which provides the pressure surface facing the conveyor screw. The pressure surface can be an integral part of a flexible barrel block encased in the casing and the means for deforming can be at least one hydraulic chamber filled with hydraulic liquid for deformation of the barrel block towards the reverse conveying section by positive pressurization of the hydraulic chamber and away from the reverse conveying section by negative pressurization of the hydraulic chamber. The casing may include at least two hydraulic chambers. In another embodiment, the means for deforming is a mechanism for radially compressing the barrel block to move the pressure surface closer to an axis of the reverse conveying section. Preferably, the mechanism translates axial motion of an actuator into radial compression of the flexible internal wall. In a yet a further preferred embodiment, the means for deforming are hydraulic piston type actuators above and below the conveyor screw for controlling the spacing between the reverse conveying elements of the screw and the pressure surface of the adjustable barrel section.

In one embodiment, the present disclosure provides a device for controlling the backpressure generation of a reverse conveying section in a screw conveyor press including a conveyor screw and a barrel housing the screw. The backpressure is controlled by adjusting the spacing between the screw and the barrel wall in at least one section of the barrel, using an adjustable barrel section. The adjustable barrel section is deformable towards the conveying device to reduce a spacing between the screw and the barrel wall and away from the conveying device to increase the spacing between the screw and the barrel wall.

In another embodiment, the present disclosure provides a method for controlling the backpressure generation of a reverse conveying section in a screw conveyor press including a conveyor screw and a barrel housing the screw. The method includes the steps of including in the barrel an adjustable barrel section which is deformable and deforming the adjustable barrel section towards the conveyor screw to reduce a spacing between the conveyor screw and an interior wall of the barrel section until a desired backpressure in the screw press is achieved. Preferably, the method includes the further step of monitoring the backpressure in the press and, when the backpressure increases above the desired backpressure, deforming the adjustable barrel section away from the conveying device to increase a spacing between the conveying screw and the adjustable barrel section and reduce the backpressure in the barrel to the desired backpressure.

In a further embodiment, the method includes further steps for preventing or reversing plugging in the conveyor screw, the further steps being monitoring a material throughput of the screw conveyor press and, if the material throughput approaches a level indicating imminent or actual plugging of the press, deforming the adjustable barrel section away from the conveyor screw to increase the spacing between the conveyor screw and the adjustable barrel section until material throughput is reestablished.

In another embodiment of the device of this disclosure, the adjustable barrel section consists of a barrel section having a flexible internal wall, preferably manufactured from a rubber or similar polymer with or without wear material inserts. The wall is preferably movable by a set of hydraulic piston type actuators both above and below the conveyor screw for controlling the spacing between the reverse conveying elements of the screw and the wall of the adjustable barrel. The adjustable barrel section itself may function as a hydraulic piston with the section including a housing for connection to adjacent barrel sections and a block of flexible material forming the flexible internal wall and separating the housing into at least two chambers, each chamber being filled with an incompressible liquid and the housing having a connector for supplying liquid into or removing liquid from the chamber for deforming the flexible internal wall by varying a pressure of the liquid in the chamber.

By changing the clearance between the reversing elements and the surrounding barrel section, the velocity of the material for a particular flow rate is manipulated, increasing or reducing the restriction to flow for the same flow rate, and thereby increasing or reducing the overall backpressure built up. By increasing the space between the reversing elements and the barrel section, additional slippage occurs in the reverse conveying section reducing the reverse force, thereby reducing backpressure.

Although the backpressure control device preferably includes a structure for actively deforming the deformable portion of the barrel block, the device can also be used in a passive mode and without the active deforming structure, or with the deforming structure disabled. The material properties of the deformable portion can be chosen to be sufficiently rigid to resist the desired operating pressure in the barrel at the reverse conveying section, but to yield at higher operating pressures. With such a device the spacing between the pressure surface and the reverse conveying section automatically increases above the desired operating pressure, thereby significantly reducing the risk of plugging, while still ensuring sufficient backpressure being maintained for continued operation of the solid/fluid separation process and apparatus.

With the new backpressure control device as described, the overall operation of a screw type solid/liquid separation device is improved as variations in dry matter and other material properties can be accommodated and managed. This backpressure control device can be used for dry solids and forms the same principle function as a process control valve on a purely liquid stream.

Other aspects and features of the present disclosure will become apparent to those ordinarily skilled in the art upon review of the following description of specific embodiments in conjunction with the accompanying figures.

### BRIEF DESCRIPTION OF THE DRAWINGS

For a better understanding of the embodiments described herein and to show more clearly how they may be carried into effect, reference will now be made, by way of example only, to the accompanying drawings which show exemplary embodiments only and in which:

FIG. 1 is a schematic illustration of a screw conveyor press in accordance with the present disclosure;

FIG. 2 is a schematic illustration of the operation of the screw conveyor press of FIG. 1;

FIG. 3 is a perspective view of an exemplary embodiment of a backpressure control device of the present disclosure;

FIG. 4 is a front elevational view of the device of FIG. 3;

FIG. 5 is a top plan view of the device of FIG. 4;

FIG. 6 is a side elevational view of the device of FIG. 5;

FIG. 7 is an exploded view of the device of FIG. 3;

FIG. 8 is a cross-sectional view of the device of FIG. 3 taken along line A-A in FIG. 5;

FIG. 9 is a cross-sectional view of the device of FIG. 3 taken along line C-C in FIG. 6;

FIG. 10 is a cross-sectional view of the device of FIG. 3 taken along line D-D in FIG. 6;

FIG. 11 is a perspective view of a deformable barrel block of the device of FIG. 3, including a steel liner for wear resistance;

FIG. 12 is a front elevational view of a deformable barrel block 260 including wear inserts;

FIG. 13A is a bottom section of a barrel block having a steel liner;

FIG. 13B is a cross-sectional view of the barrel block section of FIG. 13A; and

FIG. 14 is a cross-sectional view of another embodiment of a backpressure control device in accordance with the present disclosure.

### DETAILED DESCRIPTION OF THE PREFERRED EMBODIMENTS

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The present disclosure pertains to screw conveyor presses, also called extruder presses, in particular screw conveyor presses used for solid/liquid separation. Such screw presses generally include one, two or three conveyor screws which function in parallel and may be intercalated. In particular, the conveyor screws may include flightings which are intercalated for generating a conveying pressure and shearing forces, as desired for different applications.

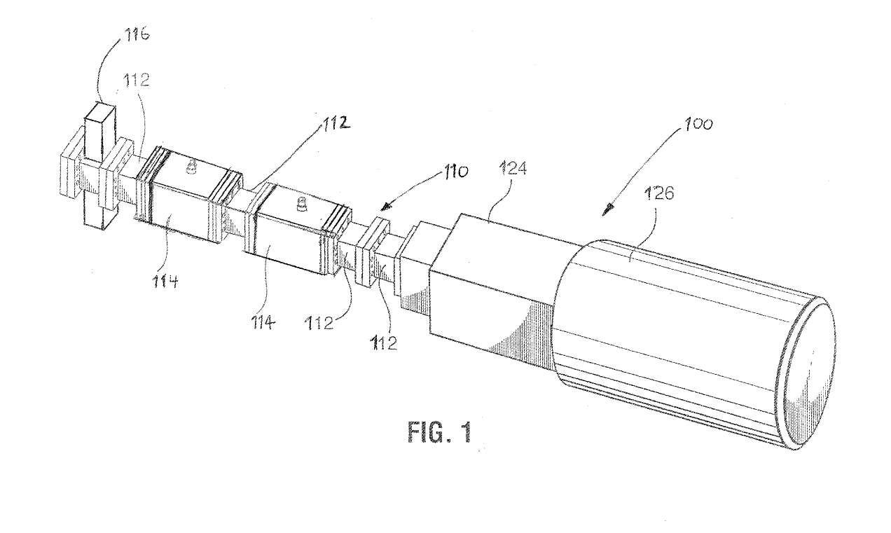

FIG. 1 is a schematic illustration of an exemplary embodiment of a screw conveyor press in accordance with the present disclosure. In this embodiment, the screw press functions as a solid/fluid separating apparatus 100. It is readily understood that the press can include, one, two or three conveyor screws. In the exemplary embodiment discussed in the present disclosure, the apparatus includes a twin-screw extruder 110 with barrel modules 112, separation modules 114, and at least one backpressure adjustment module 116, which extruder 110 is driven by a motor 126 through an intermediate gear box drive 124. Depending on the length of the barrel, the number of barrel modules 112 and separation modules 114 can be much higher than illustrated. Also, the ratio of barrel modules 112 to separation modules 114 can be varied, depending on the respective process to be executed by and in the screw press. For example, the barrel may include only one barrel module 112 at the input end of the barrel, the backpressure adjustment module 116 at the output end of the barrel and only separation modules 114 therebetween. Of course, if the solid/fluid separation apparatus 100 is to include multiple squeezing sections, two or more modules 116 can be incorporated and placed at the locations along the barrel at which the backpressure is to be controlled.

The ability of a conveyor screw to forward convey is determined by various structural features, such as a change in pitch, volume, shape and conveying direction of the forward conveying elements on the screw. Conveyor screws may include forward conveying elements as well as reverse conveying elements. Reverse directional conveying elements may be provided on the screw, which present a restriction to forward material flow and generate elevated internal pressures in the screw press, regardless of the composition of the solid/liquid material processed. In order to avoid plugging of the barrel, and to keep the material flowing continuously from the inlet end to the discharge end of the barrel, the forward conveying forces generated by the forward conveying elements must always be greater than the forces in the opposite direction created by the reverse (or “restricting”) screw elements. If at any time in any part of the screw configuration the forward forces do not exceed the reverse or flow restricting forces, the material stops flowing and the extruder becomes “plugged”. Once the extruder is “plugged, the separation process must be shut down and the extruder cleaned out, which is costly and should be avoided, especially since cleaning out can only be achieved by disassembling the extruder. Conversely in the absence of any reverse acting forces in the extruder, little internal pressure is generated and little or no liquid will be squeezed out through the filter and little or no solid-liquid separation will occur. It is therefore desirable to generate the highest internal pressures possible without plugging the extruder to maximize the solid-liquid separation action of the screw device and maintain continuous operation of the extruder.

In order to create a high internal pressure under all operating conditions, the design of forward acting conveying elements need be such that the amount of forward conveying force available always exceeds the highly variable reverse conveying forces, which can occur under various operating conditions. Of particular note are changes in the material friction factor and rheology as a result of varying water removal and variation in the composition of the input material.

In a real world continuous operation, the amount of water removed varies depending on the screw rpm, the material feed rate and the composition of the material at the intake. The more water is removed, the drier the material becomes and the more the properties which affect the forward and reverse forces change. Thus, since the friction factor and rheology properties commonly vary exponentially with water content, the forward conveying ability of the screw configuration must be conservatively designed to account for any and all changes expected in reverse acting forces to prevent plugging. A conservative design of the forward acting conveying elements necessarily stretches the length of the system, which imposes serious limits on the system, since the system's capacity to perform other functions such as water injection for washing of the solids after water has been squeezed out is curtailed if the conservative design stretches over the full system length. As the force effect of dryness on the friction factor and rheology increases exponentially, the amount of forward conveying conservatism needs to be great in order to significantly reduce the chance of plugging.

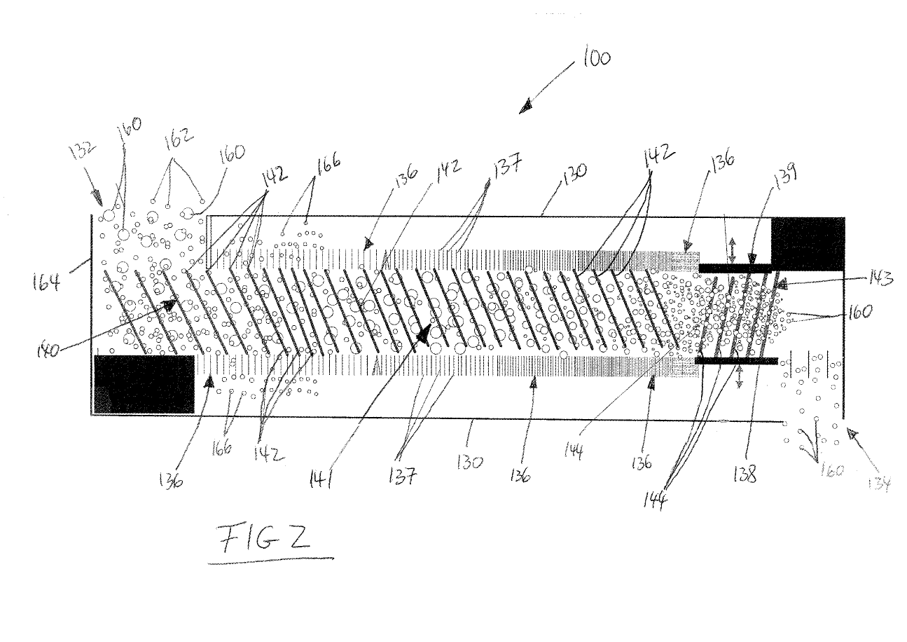

FIG. 2 is a schematic illustration of another exemplary screw conveyor press 100 in accordance with the present disclosure and an exemplary process of operating the press. The press has a barrel 130 with an input end 132, an output end 134, separating sections 136 with filter plates 137 and a backpressure section 138 with the backpressure control module 139. The press further includes a conveyor screw 140 having a forward conveying section 141 with forward conveying elements 142 and a reverse conveying section 143 with reverse conveying elements 144. A solid/liquid mixture including solids 160 and liquids 162 is fed into the hopper 164 at the input end 132. The mixture is conveyed forward by the forward conveying elements 142. Free water 166 is filtered out early in the separation process in the first separating sections 136. Separating modules for use as separating sections 136 in solid-liquid separation presses, and in particular those useful as filtering devices in a screw conveyor press in accordance with the present disclosure are described in co-pending applications US 2012/0118517 and U.S. Ser. No. 61/909,594, the disclosures of which are incorporated herein by reference in their entirety. However, the type of filtering device or separation module used in the exemplary embodiments of the present disclosure is not critical and the construction and function of different filtering or separating modules will not be discussed in any more detail herein.

As liquid is progressively squeezed out of the solid-liquid material along the length of the screw extruder 100, its dry matter increases and thus its viscosity increases, resulting in a progressively higher restriction to flow and higher pressure developed along the length of the extruder 100. This is especially true for the reverse conveying elements 144, which are creating most of the restriction to flow at the end of the screw device 100, as they are exposed to the highest dry matter material. In essence, to push material past the reverse conveying elements, there is an uneven “tug of war” between all the forward conveying elements 142, which contain less viscous material and of which there are many, and the dry material reverse conveying elements 144, of which there are only few.

There is always slippage in all the conveying screws. Slippage in the forward conveying elements 142 occurs much more easily as the dry matter content is lower (more liquid) than the in the dry matter in the reverse conveying elements 144. This creates the need for a much larger number of forward acting conveying elements 142 than reverse acting elements 144. If at any time the slippage of the forward acting conveying section 141 is to the extent that these sections cannot generate enough force/pressure to overcome the reverse acting forces of the reverse conveying section 143, material flow will stop and in a practical sense the extruder is “plugged”.

Necessarily, in order to achieve optimum solid/liquid separation, the system must operate with relatively high dry matter material in the reverse conveying section 143, which requires generation of high forward forces by the forward conveying section 141 at all time. As the friction factor or resistance to flow of relatively dry material in the reversing conveyors 144 increases exponentially at a much greater rate with increasing dryness than the wetter forward conveying section 141, it only takes a slight change in dry matter in the reversing section 143 to greatly affect the solid liquid separation and operation of the twin screw extruder 100. Combining this with the fact that the reverse conveying section 143 is much smaller than the forward conveying section 141, being able to control this section in a screw extruder will be a large factor for optimizing solid/liquid separation.

Once an internal screw configuration is set in a conventional screw press, the only way to affect the conveying forces in the conveying elements is to change the rotational speed of the conveyor screws. The higher the speed, the higher the forces, but in relation to the forward and the reversing sections the reversing section sees a much greater effect. As speed is increased, internal pressure increases, slippage increases, dry matter of the material increases but as the effect in the reverse conveying section 143 increases at a greater rate than it does in the forward conveying section 141, it is possible that there comes a point where flow will stop and the extruder will be plugged.

The illustrated exemplary extruder unit of the present disclosure includes a twin screw assembly having parallel or non-parallel screws with the flighting of the screws intercalated at least along a part of the length of the extruder barrel to define close-clearance between the screws and the screws and the barrel. Cylindrical or tapered, conical screws can be used. Preferred are tapered, conical screws, most preferably non-parallel conical screws. The close clearance creates nip areas with increased shear. The nip areas create high pressure zones within the barrel which propel material forwardly, while the material is kneaded and sheared. A specialized fluid separation unit is also provided, which allows fluids to be efficiently extracted from the extruded mixture.

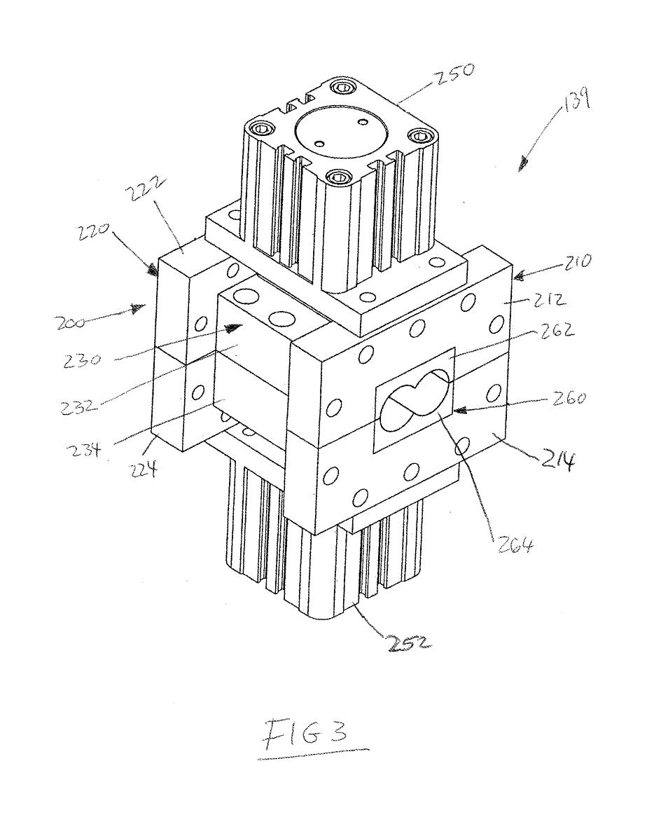

In order to allow adjustment of the backpressure produced in the reverse conveying section 143 by the reverse conveying elements 144, the present disclosure teaches a solution not possible with the screw conveyor presses of the prior art, namely the adjustment of the spacing between the barrel and the conveyor screw by way of a backpressure control module 139. An exemplary embodiment of a backpressure control module in accordance with the present invention will be discussed in the following with reference to FIGS. 3 to 12.

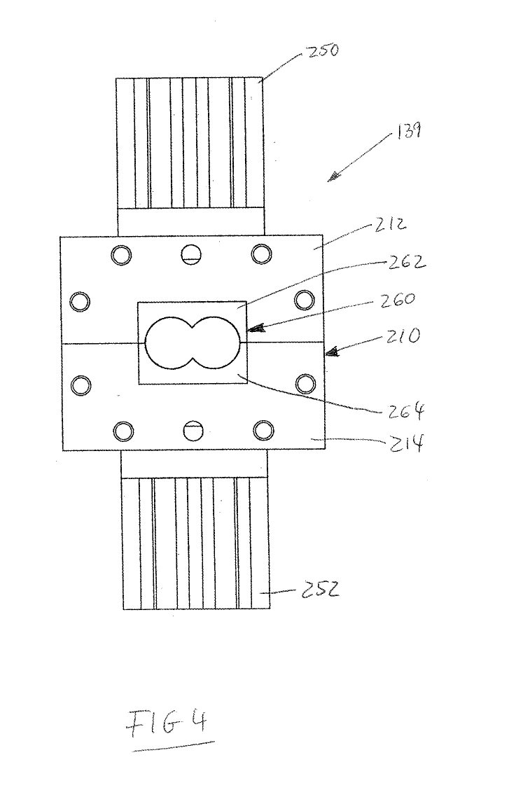

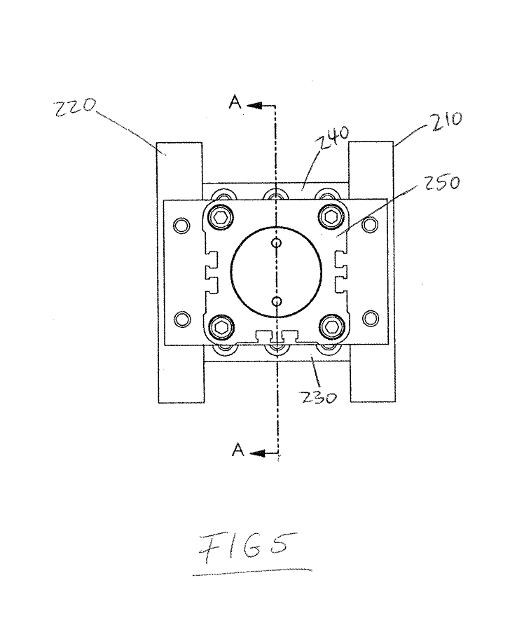

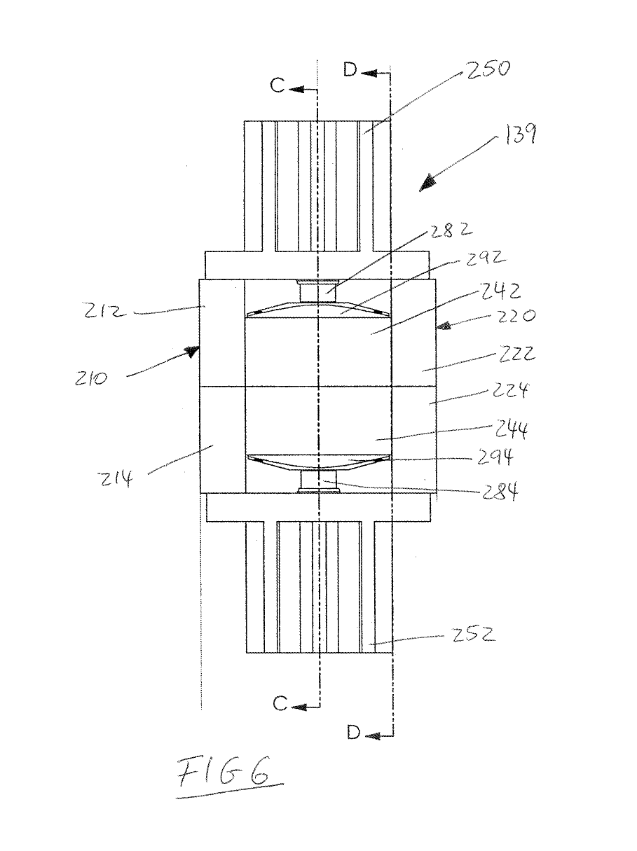

FIG. 3 is a perspective view of a backpressure control module 139 in accordance with the present disclosure including a casing 200, a deformable barrel block 260 and a pair of top and bottom hydraulic units 250, 252. The casing 200 is assembled from a front wall 210, horizontally divided into a top half 212 and a bottom half 214, a back wall 220, horizontally divided into a top half 222 and a bottom half 224 and casing walls 230, 240 (only 230 shown, for 240 see FIG. 5), also horizontally divided into top and bottom halves 232, 234 and 242, 244 (see FIG. 6). For ease of manufacture and assembly, the barrel block 260 is also horizontally divided into a top portion 262 and a bottom portion 264. FIG. 4 is a front elevational view of the backpressure control module 139 of FIG. 3, showing the top and bottom halves 212, 214 of the front wall 210, the top and bottom portions 262, 264 of the barrel block 260 and the top and bottom hydraulic units 250, 252. FIG. 5 is a top plan view of the backpressure control module 139 of FIG. 3, illustrating the front and back walls 210, 220, the top hydraulic unit 250 and the left and right casing walls 230, 240. FIG. 6 is a side elevational view of the backpressure control module 139 of FIG. 3, illustrating the top and bottom halves 242, 244 of right casing wall 240 (left casing wall 230 and halves 232, 234 not shown). FIG. 6 further illustrates pistons 282 and 284 of the top and bottom hydraulic units 250, 252 and the pressure plates 292 and 294 respectively affixed thereto.

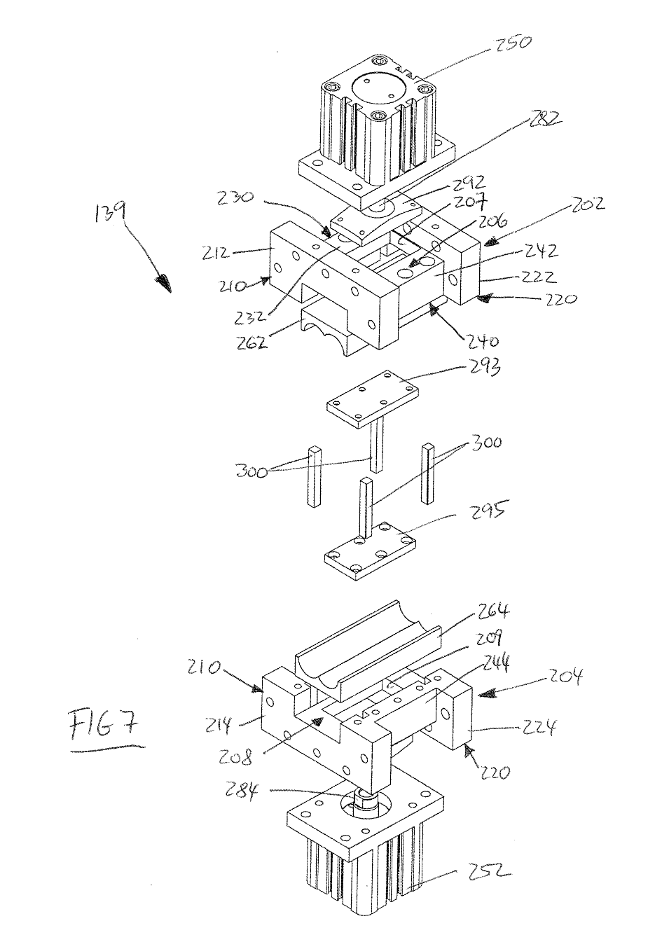

FIG. 7 is an exploded view of the backpressure control module 139 of FIG. 3, illustrating a top portion 202 and a bottom portion 204 of the module 139. The top portion 202 includes top hydraulic unit 250 with piston 282 and associated pressure plate 292 and spacer plate 293, top halves 212 and 222 of front and back walls 210, 220, top halves 232, 242 of left and right sidewalls 230, 240 and top portion 262 of barrel block 260. The bottom portion 204 includes bottom hydraulic unit 252 with piston 284 and associated pressure plate 294 and spacer plate 295, bottom halves 214 and 224 of front and back walls 210, 220, bottom halves 234, 244 of left and right sidewalls 230, 240 and bottom portion 264 of barrel block 260. In the preferred embodiment shown in FIG. 7, the top halves 212 and 222 of front and back walls 210, 220 and the top halves 232, 242 of left and right sidewalls 230, 240 are all integrated into a top casing section 206 made from a single block of material for added strength. Likewise, bottom halves 214 and 224 of front and back walls 210, 220 and bottom halves 234, 244 of left and right sidewalls 230, 240 are all integrated into a bottom casing section 208 and made from a single block of material for added strength. Top casing section 206 includes a central vertical aperture 207 for receiving the top pressure plate 292 and spacer plate 293, while bottom casing section 208 includes a central vertical aperture 209 for receiving the bottom pressure plate 294 and spacer plate 295. Pressure plates 292 and 294, with attached spacer plates 293 and 295 respectively, rest against top and bottom portions 262 and 264 of the barrel block 260, for compressing the top and bottom portions 262, 264 of the barrel block through transmission of the thrust force generated by the hydraulic units 250, 252 through pistons 282, 284 and the associated pressure plates 292, 294. The spacer plates 293, 295 can be replaced to adjust the degree of compression exerted on the barrel block 260 during the maximum stroke of pistons 282, 284. With the use of the spacer plates, the degree of compression can be adjusted without having to completely disassemble the screw press. Only removal of the top and bottom hydraulic units 250, 252, replacement of the installed spacer plates with thicker or thinner plates and reattachment of the hydraulic units is required. FIG. 7 also illustrates vertical alignment bars 300, which are received in recesses 302 provided in the casing walls, to align the top and bottom portions 262, 264 of the barrel block 260 and to lock the barrel block 260 in the top and bottom portions 202, 204 of the module 139.

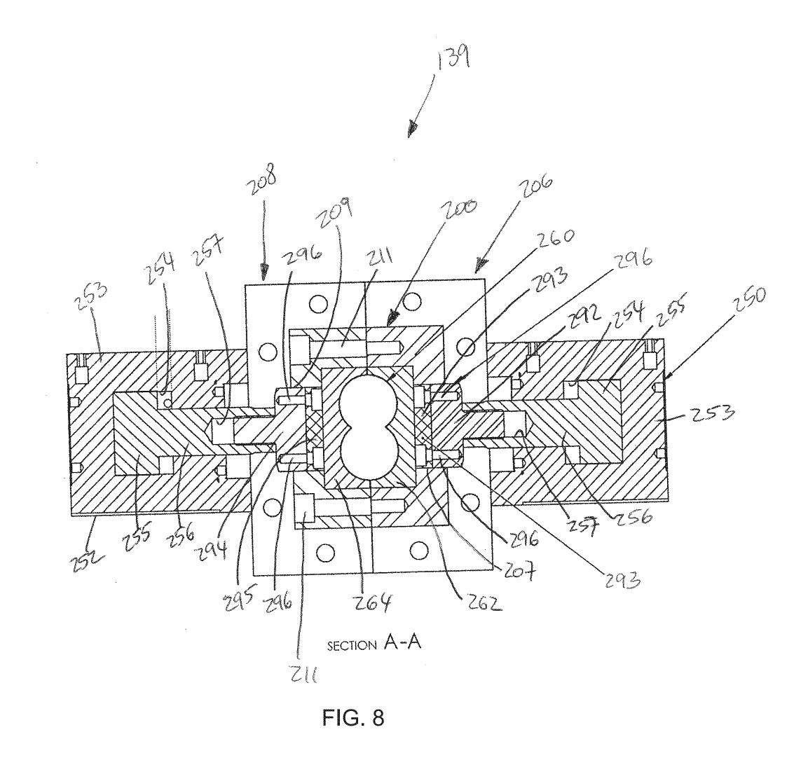

FIG. 8 is a cross-sectional view of the backpressure control module 139 of FIG. 3 taken along line A-A in FIG. 5 and FIG. 9 is a cross-sectional view of the backpressure control module 139 of FIG. 3 taken along line C-C in FIG. 6. As is apparent from FIGS. 8 and 9, each hydraulic unit 250, 252 includes a housing 253 having a central cylinder bore 254 and a hydraulic piston 255 reciprocatable in the bore 254 by hydraulic fluid supplied to a space ahead or behind the piston 255 from a hydraulic pump (not shown), as will be readily apparent to a person skilled in the art of hydraulic actuators. The pressure of the hydraulic fluid is directly proportional to the internal pressure in the material, which is being squeezed through the barrel block 260. Thus, the hydraulic system preferably includes a pressure sensor (not shown) for monitoring of the fluid pressure and, thus monitoring of the backpressure in the screw press 100. The piston 255 incorporates a pressure rod 256 with a threaded end socket 257 into which the associated pressure plate 292 or 294 is screwed. The top hydraulic unit 250 is bolted (not shown) to the top casing section 206 for alignment of the pressure plate 292 with the central aperture 207. Correspondingly, the bottom hydraulic unit 252 is bolted (not shown) to the bottom casing section 208 for alignment of the pressure plate 294 with the central aperture 209. Spacer plates 293, 295 are fastened by bolts 296 to the respectively associated pressure plate 292, 294. A pressure transducer (not shown) can be incorporated anywhere in between the pressure plates 292, 294 and the associated spacer plates 293, 295 or between the spacer plates 293, 295 and the barrel block 260 for measuring the pressure exerted on the block 260, which, as previously mentioned, is directly proportional to the pressure in material being forced through the block 260. This represents another setup for monitoring the pressure in the press. Other transducers which produce a signal proportional to the pressure exerted on the block 260 can also be used for monitoring of the internal pressure in the screw press 100. The top and bottom portions 262, 264 of barrel block 260 are clamped together by the top and bottom sections 206, 208 which fittingly surround the barrel block 260 when fastened together by bolts 211. By tightly and fittingly clamping the barrel block 260 in the casing 200, movement of the barrel block 260 in the casing 200 due to rotation of the conveyor screws (see FIG. 9), is prevented.

During operation, the backpressure control module 139, which is preferably installed in the screw press 100 at the location of the reverse conveying elements 144 (see FIG. 2), is used for backpressure control by adjustment of the spacing 340 between the conveyor screws 140 and a pressure surface 261 of the barrel block 260 facing the conveyor screws 140. The spacing 340 can be adjusted by deforming the deformable material of the barrel block 260 to move the pressure surface 261 closer to the conveyor screws 140. In the embodiment illustrated in FIG. 9, that is accomplished by supplying to the hydraulic units 250, 252 a pressurized hydraulic liquid for forcing the pistons 255 and connected pressure rods 256 to move outward towards the barrel block 260. This movement forces the pressure plates 292, 294 towards the top and bottom barrel sections 262, 264 respectively, thereby pressing the connected spacer plates 293, 295 into the material of the top and bottom barrel sections 262, 264 respectively. Since the barrel block 260 is tightly clamped within the casing 200, the material of the barrel block 260 cannot avoid the compression exerted by the spacer plates 293, 295 in any direction, but towards the conveyor screws 140. This deformation moves the pressure surface 261 closer to the conveyor screws 140, which narrows the spacing 340 and allows for adjustment of the backpressure generated by the reverse conveying elements 144. Should the backpressure become too high, the compression of the barrel block can be reversed by supplying to the hydraulic units 250, 252 a pressurized hydraulic liquid for forcing the pistons 255 and connected pressure rods 256 to move inward and away from the barrel block 260.

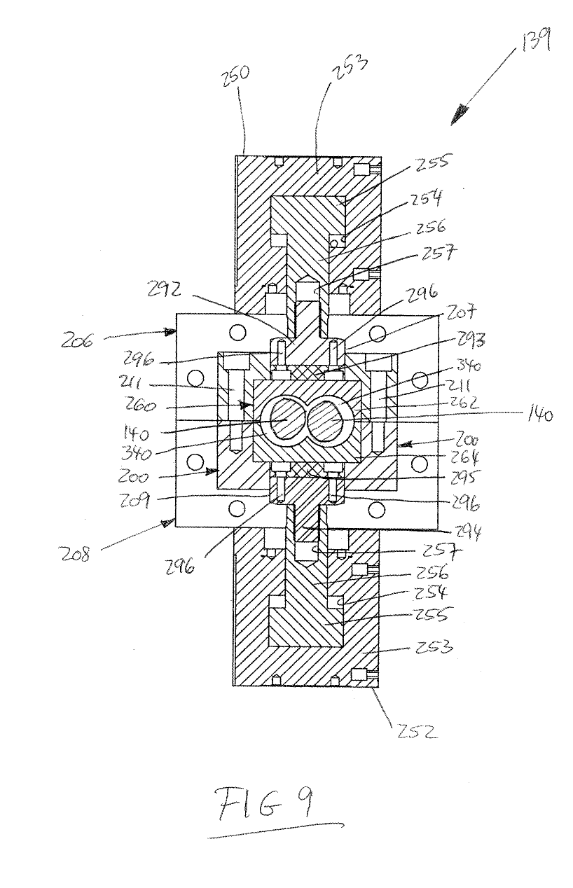

FIG. 10 is a cross-sectional view of the backpressure control module 139 of FIG. 3 taken along line D-D in FIG. 6. FIG. 10 illustrates hydraulic units 250, 252 including a housing 253, pistons 282, 284 and the associated pressure plates 292 and 294. The top hydraulic unit 250 is bolted (not shown) to the top casing section 206 and the bottom hydraulic unit 252 is bolted (not shown) to the bottom casing section. The top and bottom portions 262, 264 of barrel block 260 are clamped together by the top and bottom sections 206, 208 which fittingly surround the barrel block 260 and tightly and fittingly clamp the barrel block 260 in the casing 200, movement of the barrel block 260 in the casing 200 due to rotation of the conveyor screws (see FIG. 9), is prevented by spacer bars 300.

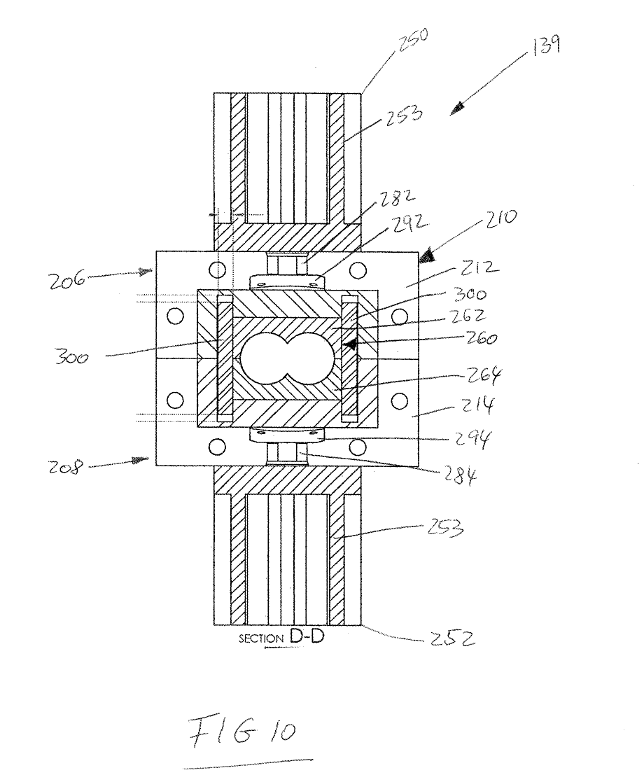

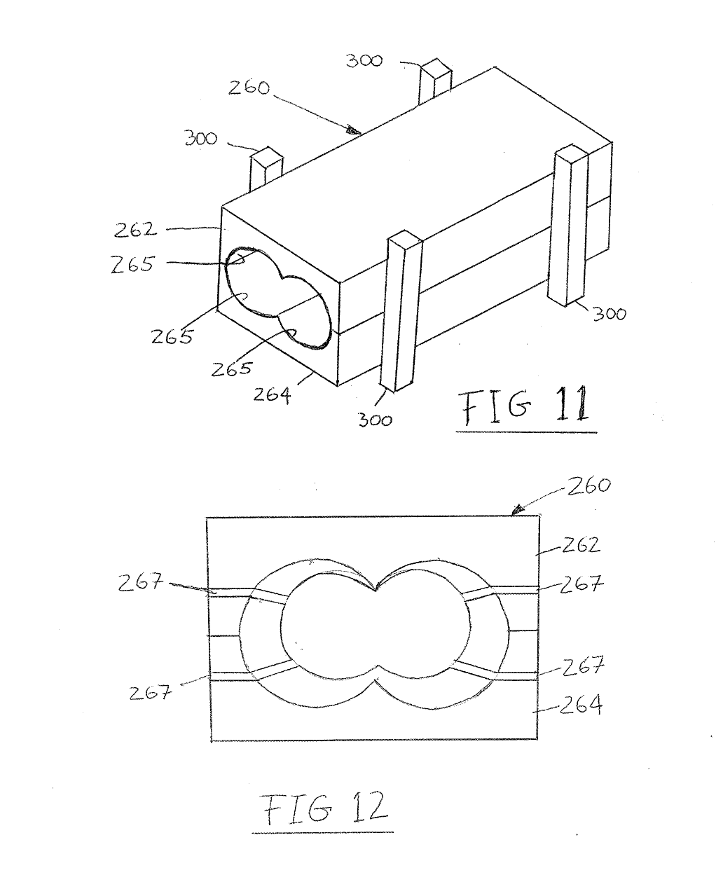

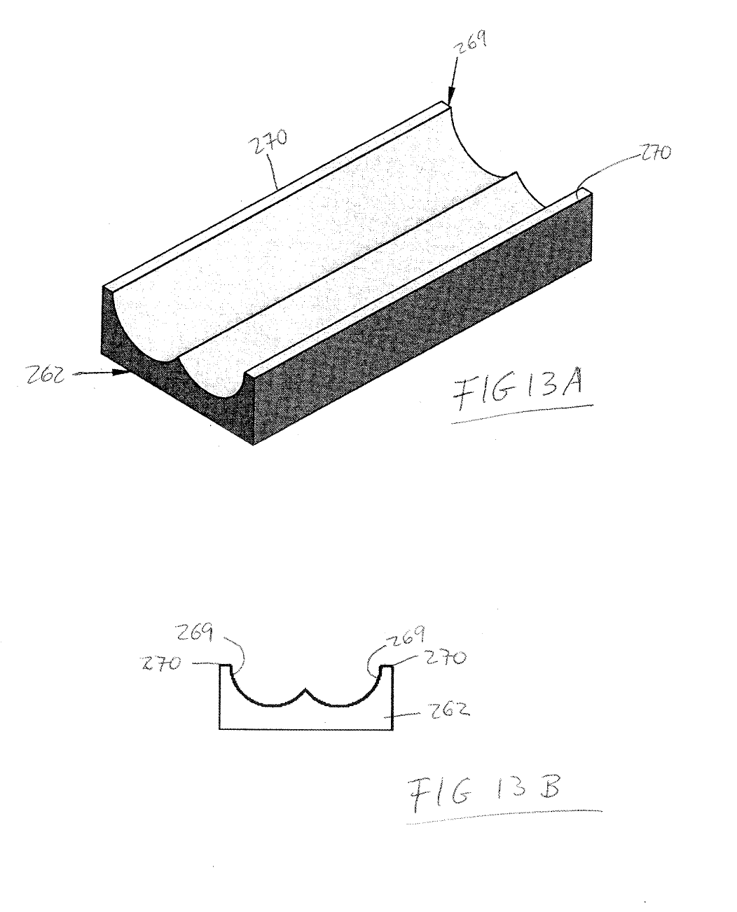

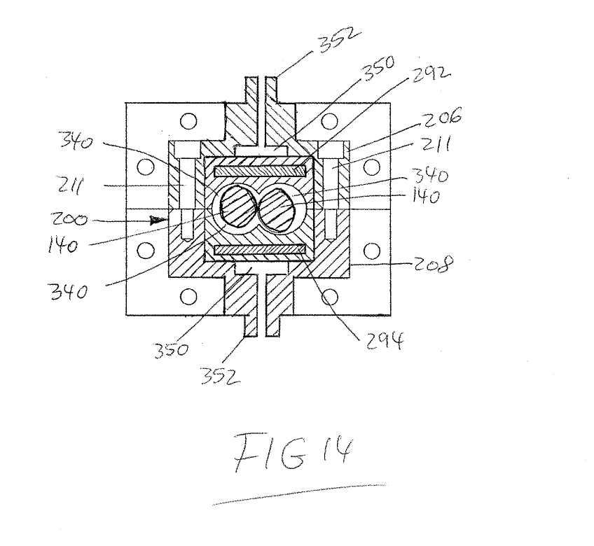

FIG. 11 is a perspective view of a deformable barrel block 260 of the device of FIG. 3. The deformable barrel block 260 is made of deformable material, preferably elastically deformable material and has a pressure surface 261 for facing the conveyor screws 140. Rubber, elastic polymers or similar elastically deformable materials can be used for the barrel block. Although manufacturing the whole block of the same material represents the easiest approach for manufacturing purposes, deformable materials, especially elastic materials are costly and do not have superior wear resistance. Thus, the barrel block 260 may be made of deformable and non-deformable portions as illustrated in FIGS. 12, 13A and 13B. Another alternative construction for the barrel block 260 would be to use a regular barrel section, cut out a central portion (not shown) which is located under the spacer plates 293, 295 and to replace the cut out portion with deformable, preferably elastic, material. If a rubber material is used, the material can be directly vulcanized onto the remaining pieces of the sliced barrel section (not illustrated). Other constructions wherein the barrel block 260 includes one or more deformable sections are also conceivable and included in the teachings of the present disclosure. Preferably, the barrel block 260 is manufactured in a pair of identical top and bottom sections 262 and 264, for ease of manufacturing and molding of the barrel block. In the installed condition, as illustrated in FIGS. 8-10, the identical top and bottom portions 262, 264 are stacked with the top portion 262 placed upside down on top of the bottom portion for the pair of grooves 265 in each portion together forming a pair of adjacent conveyor screw barrels. Spacer rods 300 are used for lateral alignment of the top and bottom portions 262, 264. In the preferred embodiment of the barrel block shown in FIG. 11, the grooves 265 are provided with a wear liner as will be described in more detail in relation to FIGS. 13A and 13B.

FIG. 12 is a front elevational view of a deformable barrel block 260 including in th pressure surface 261 wear inserts 267 made of wear resistant material, for example metal, preferably steel, or hard plastics, which preferably also provides a friction reducing finish, such as tetrafluoroethylene. The wear inserts 267 can be incorporated into the top and bottom portions 262, 264 during molding or by slicing the portions after molding and sandwiching the slices and the inserts, preferably with the help of an adhesive.

FIG. 13A is a perspective view of a barrel portion 262 or 264 including as the pressure surface 261 a wear liner, in the illustrated preferred embodiment a thin layer of steel as is best seen from FIG. 13B, which is a cross-sectional view of the barrel portion of FIG. 13A. The barrel portion 262, 264, includes a steel liner 269, which is molded to exactly follow the groove contour of the barrel portion and extends laterally past the grooves to the outer edge 270 of the barrel portion. This locks the liner 269 against movement when the barrel portions 262, 264 are clamped together within the housing 200 as discussed above. The liner 269 may be inserted into the mold for bonding to the barrel portion during the molding process, or may be adhesively connected to the barrel portion after molding of the barrel portion is completed.

FIG. 14 shows an alternate embodiment of the backpressure control device 139 of the present disclosure. To simplify the construction of the device, the pressure plates 292, 294 are embedded into the top and bottom portions 262, 264 of the barrel block 260, the hydraulic units 250, 252 and their pistons are omitted completely and the compression of the barrel block is achieved by pressurizing a small chamber 350 provided in the casing 200 above and below the barrel block 260. Pressurized fluid (compressed gas or hydraulic fluid) is supplied to chamber 350 through a flange 352 integral with the top and bottom casing 206, 208. By controlling the pressure in the chamber 350, the spacing 340 between the barrel block 260 and the conveyor screws 140 can be controlled. An increase in pressure deforms the barrel block 260 towards the conveyor screws 140, thereby decreasing the spacing 340, while a decrease in pressure allows the barrel block material to relax and retract from the conveyor screws, thereby increasing the spacing 340. By decreasing the spacing 340, the backpressure achievable in the screw conveyor press of the present disclosure, including a backpressure device as shown in FIG. 14, is increased. Conversely, increasing the spacing reduces the backpressure.

If the bores in the barrel block, which means the depth or radius of the grooves in the barrel block portions, are selected to be oversized relative to the conveyor screws respectively used, the backpressure control device of the present disclosure can be used not only for backpressure control, but also for preventing plugging. This is achieved by clamping the barrel block in the casing and compressing the barrel block until the desired backpressure is achieved. By monitoring the material throughput of the screw press, one can determine when the throughput decreases to the level which indicates the onset or occurrence of plugging. At that point, a gradual decreasing of the compression of the barrel block may result in sufficient decrease in the backpressure to reestablish the desired throughput. If plugging conditions persist, the compression of the barrel block can be completely released, preferably virtually instantly, to allow the formed plug to be forced out of the reverse conveying section, due to the complete lack of backpressure. This will virtually ensure a plug free operation or will at least allow unplugging of the screw press to be carried out without dismantling of the press.

Although this disclosure has described and illustrated certain embodiments, it is also to be understood that the system, apparatus and method described is not restricted to these particular embodiments. Rather, it is understood that all embodiments, which are functional or mechanical equivalents of the specific embodiments and features that have been described and illustrated herein are included.

It will be understood that, although various features have been described with respect to one or another of the embodiments, the various features and embodiments may be combined or used in conjunction with other features and embodiments as described and illustrated herein.

1. A device for controlling backpressure in a screw conveyor press including a conveyor screw and a barrel housing the conveyor screw, the device comprising a barrel block for forming an axial section of the barrel and having a pressure surface for facing the conveyor screw, at least a portion of the barrel block being deformable for adjusting a spacing between at least a portion of the pressure surface and the conveyor screw.

2. The device of claim 1, further including an arrangement for deforming the deformable portion.

3. The device of claim 2, wherein the arrangement is a mechanism for deforming the deformable portion.

4. The device of claim 3, wherein substantially the whole barrel block is made of deformable material.

5. The device of claim 4, wherein the device includes a casing for enclosing the barrel block and the arrangement is positioned between the casing and the barrel block.

6. The device if claim 5, wherein the arrangement is a hydraulic arrangement for compressing the barrel block.

7. The device of claim 5, wherein the arrangement is a mechanism for compressing the barrel block.

8. The device of claim 1, wherein the deformable portion is made of elastically deformable material.

9. The device of claim 8, wherein substantially the whole barrel block is made of elastically deformable material.

10. A method of controlling backpressure in a screw conveyor press including a conveyor screw and a barrel housing the conveyor screw, the method comprising the steps of deforming an adjustable section of the barrel for modifying a spacing between the section of the barrel and the conveyor screw.

11. The method of claim 10, wherein, for increasing backpressure in the screw conveyor press, the step of deforming includes deforming the adjustable section of the barrel towards the conveying screw for decreasing the spacing between the section of the barrel and the conveyor screw.

12. The method of claim 10, wherein, for decreasing backpressure in the screw conveyor press, the step of deforming includes deforming the adjustable section of the barrel away from the conveyor screw for increasing the spacing between the conveyor screw and the barrel section.

13. The method of claim 10, wherein the section of the barrel is deformed towards the conveying screw for decreasing the spacing between the adjustable section of the barrel and the conveyor screw and deforming the adjustable section away from the conveying screw for increasing the spacing.

14. The method of claim 13, wherein the adjustable section of the barrel is made of elastically deformable material and the deforming towards the conveying screw includes elastically deforming the adjustable section of the barrel from a relaxed condition to a compressed, operating condition, and the deforming away from the conveyor screw includes allowing the adjustable section to relax at least partially from the compressed condition.

15. The device of claim 1 for controlling backpressure generation of a reverse conveying section in the screw conveyor press, wherein the barrel block is an adjustable barrel block for forming a section of the barrel surrounding at least an axial portion of the reverse conveying section, the adjustable barrel block including a deformable portion deformable to and fro the conveyor screw and a pressure surface facing the conveyor screw, and means for deforming the deformable portion for adjusting a spacing between the reverse conveying section and the barrel section by deforming the deformable portion to move the pressure surface closer to the reverse conveying section to reduce the spacing or further away from the reverse conveying section to increase the spacing.

16. The method of claim 10, wherein the adjustable section is an adjustable barrel block and the method comprises the further step of including in the barrel the adjustable barrel block for forming a section of the barrel surrounding at least an axial portion of the reverse conveying section, the adjustable barrel block including a pressure surface facing the reverse conveying section and a deformable portion deformable to and fro the conveyor screw, and the deforming step includes the step of deforming the deformable portion for adjusting the spacing between the reverse conveying section and the pressure surface by deforming the deformable portion towards the reverse conveying section to reduce the spacing until a desired backpressure in the screw press is achieved.

17. The method of claim 16, comprising the further steps of monitoring the backpressure in the press and, when the backpressure rises above the desired backpressure, deforming the deformable portion away from the reverse conveying section to increase the spacing to reduce the backpressure in the barrel to the desired backpressure.

18. The method of claim 17, comprising, for preventing or reversing plugging in the reverse conveying section, the further steps of monitoring a material throughput of the screw conveyor press and, when the material throughput approaches a value indicating imminent or actual plugging of the press, deforming the deformable portion away from the reverse conveying section to increase the spacing until material throughput is reestablished.

19. An adjustable barrel section for controlling backpressure generation of a reverse conveying section in a screw conveyor press including a conveyor screw and a barrel housing the screw, the barrel including multiple sections, the adjustable barrel section comprising a casing for incorporation into the barrel and connection to at least one other barrel section, and an adjustable barrel block for surrounding at least an axial portion of the reverse conveying section and having a pressure surface for facing the reverse conveying section, the adjustable barrel block having a deformable portion deformable to move the pressure surface closer to or further away from the reverse conveying section for adjusting a spacing between the pressure surface and the reverse conveying section, and means for deforming the deformable portion for adjusting the spacing between the reverse conveying section and the pressure surface.

20. The adjustable barrel section of claim 19, wherein the deformable portion is made of elastically deformable material.

21. The adjustable barrel section of claim 20, wherein the deformable section is made of rubber material, or similar polymeric elastic material.

22. The adjustable barrel section of claim 21, wherein substantially the whole adjustable barrel block is deformable and the pressure surface includes at least one of a friction reducing finish and a wear reducing finish.

23. The adjustable barrel section of claim 22, wherein the wear reducing finish is at least one wear material insert forming part of the pressure surface.

24. The adjustable barrel section of claim 23, wherein the at least one wear material insert is a metal sheet.

25. The adjustable barrel section of claim 19, wherein the means for deforming are hydraulic piston type actuators above and below the conveyor screw for controlling the spacing between the reverse conveying elements of the screw and the pressure surface of the adjustable barrel block.

26. The adjustable barrel section of claim 19, wherein the pressure surface is an integral part of a flexible barrel block encased in the casing and the means for deforming is at least one hydraulic chamber filled with hydraulic liquid for deformation of the barrel block towards the reverse conveying section by positive pressurization of the hydraulic chamber and away from the reverse conveying section by negative pressurization of the hydraulic chamber.

27. The adjustable barrel section of claim 19, wherein the means for deforming is a mechanism for radially compressing the deformable portion towards an axis of the reverse conveying section.

28. The adjustable barrel section of claim 27, wherein the mechanism translates axial motion of an actuator into radial compression of the deformable portion.
